(19) United States
(12) Patent Application Publication
(10) Pub. No.: US 2004/0057382 A1
(43) Pub. Date: Mar. 25, 2004

(54) Method of distributed voice transmission

(76) Inventors: Anurag Kumar, Bangalore (IN); Rama. Kumar Mopidevi, Durga Temple (IN)

Correspondence Address: John A. Parrish, Law Offices of John A. Parrish, Suite 300, Two Bala Plaza, Bala Cynwyd, PA, 19004, US

(21) Appl. No.: 09/972,727

(22) Filed: Oct. 5, 2001

(30) Foreign Application Priority Data
Oct. 9, 2000 (IN) 917/DEL/2000

(51) Int. Cl. H04L 12/26; H04L 1/00

(52) U.S. Cl. 370/252; 370/352

(57) ABSTRACT

The disclosed invention provides a method for reducing the delay in speech play out in network conferencing such as in the Internet and the like communication systems. The method entails steps directly computing excess play out delay for a given target loss probability; estimating the excess delay required at the beginning of a talk spurt, such that straggling packets catch up; providing a built-in notion of target loss probability (TLP) as a parameter and producing excess play out delay; binding late packet probability, thereby emerging a class of algorithms.

This application claims the benefit of priority to Indian Patent Application 917/DEL/2000 filed Oct. 9, 2000.

### TITLE OF THE INVENTION

Method of Distributed Voice Transmission

### FIELD OF THE INVENTION

The present invention relates to a method for minimizing end-to-end voice delay in packet telephony by estimation and control of packet voice play out delay.

### BACKGROUND OF THE INVENTION

Network like Internet connects millions of users worldwide, and using telephony, facilitates conferencing from distant places. In voice transmission, data collection networks and their communication protocols have been specifically designed for data collection and forwarding through wireless and hardwired links, and they are designed in attempts to optimize overall data flow through the network. Among the flow optimizing techniques used, the data is segmented and packetized in preparation for transmission. Packet by packet, the data is transmitted as channel bandwidth becomes available. These packetized voice data are generated during activity periods of the voice source. The activity periods or talk spurts in speech are identified by a voice activity detector (VAD) mechanism. These speech packets are then launched individually into the packet network. It is likely that some speech packets launched into the packet network may lag behind others. Data packets traverse the Internet by being routed from one node to the next. Each of these hops takes the packet closer to its destination. Each node along the route is designated by a globally unique IP address. Each node in the route looks at the destination address contained in the header of an IP packet and sends the packet in the direction towards its destination. At any time, a node along a particular route can stop accepting, or block one or more packets. This may be due to any number of reasons; congestion, maintenance, node crash, etc. Each routing node constantly monitors its adjacent nodes and adjusts its routing table when such problems occur. As a result, sequentially numbered packets may take different routes as they traverse the Internet.

The audio quality of duplex phone conversation over the Internet is often poor because of delays of transmission of packets, lost packets and lost connections. The delays are unpredictable and are usually caused by the dynamically changing data loads on the network and the changing and often long routes through which the data must pass. Existing methods for reducing this delay problem have included the use of (1) dedicated transmission lines, (2) permanent virtual circuits in which a route is reserved for the duration of the real-time data transmission, and (3) redundantly sending all of the critical data so that the delay experienced by the user will be only the delay of the shortest path. Methods 1 and 2 above are undesirable for two-way voice communications due to the high cost of the dedicated path (channel) which must be present during the entire conversation. Additionally, these methods (1) and (2) are not universally available to most Internet users. Method (3) is undesirable because it wastes network resources by sending multiple copies of the data, although long delays along a given path are generally only occasional.

The increase in consumer interest in the Internet, for example the downloading of graphics using the World-Wide Web, has placed an increased demand for transmission and processing time. It is believed, by some, that such increased demand will result in even poorer audio duplex phone quality.

With each added feature, the amount of data communicated over the Internet increases, causing delays and frustration to users. Some experts contend that the backbone of the Internet will become overburdened in the near future due to the increase in the number of users and the amount of data being transferred during a typical session. One type of electronic conferencing program which is becoming increasingly useful in business and personal matters is meeting software. A meeting program allows two or more users to communicate aurally and visually. The aural portion is performed by digitizing each participants voice and sending the audio packets to each of the other participants. The video portion may, for example, send graphic images of selected participants to each participant of the meeting and/or allow users to share a drawing program.

U.S. Pat. No. 5,530,699 discloses a method for distributed voice conferencing in a fast packet network. Fast packet networks sample, digitize and compress voice communication, placing the digital information into “fast packets” or “cells”. A fast packet is discrete segment of digital information. Typically, one speaker generates 25 to 200 fast packets per second. Thus, in ten minute conversation, a speaker may generate thousands of fast packets. Each fast packet contains, among other things, the logical channel number to reach the destination node and the digital representation of a portion of the speech. Upon receipt of the packets, the destination node depacketizes the data, optionally decompresses the digitized speech and then converts the digitized speech into a speech waveform. The destination node plays the sound for the user at the destination node.

U.S. Pat. No. 5,883,891 sought to improve the audio quality of voice communication over the Internet. It provides such quality by reconstituting delayed and/or missing packets based upon the packets which arrive in time. The system was “robust” because packets constituting a matrix (a group of 3-20 packets) are deliberately transmitted over multiple routes. If one route is subject to delays, or loses packets, the lost or delayed packages may be fully reconstituted. The U.S. Pat. No. 5,883,901 discusses a server receiving the phone call from a caller (host computer) using a software program which arranges each set of incoming voice packets into vertically (imaginary), xy matrix (2-dimensional) or a 3-dimensional matrix. It was discussed that a matrix consists of rows and columns of 25 packets formed into 5 rows and 5 columns. A sixth row is a check packet and is based on the 5 packets in its column. That server (source node) transmits the data packets and check packets over the Internet to another server (destination node) who places a telephone call over the local telephone network to the callee.

U.S. Pat. No. 5,963,217 discloses a network conference system using limited bandwidth to generate locally animated displays, for communicating over a network by transferring a data stream of text and explicit commands from a host computer to one or more participant computers. The participant computers generate audible speech and implicit commands responsive to said text and generate animation responsive to said implicit and explicit commands. The disclosure in the U.S. Pat. No. 5,963,217 provided significant advantages over prior art electronic conferencing programs, particularly with regard to the Internet and other on-line services. Most importantly, the bandwidth of transferring digital audio over a network is greatly reduced because text is transferred between computers and is translated into audible speech at the participating computers.

In packet telephony, packets are generated during activity periods of the voice source. The activity periods or talk spurts in speech are identified by a voice activity detector (VAD) mechanism, as illustrated in FIG. 1 of the accompanying drawing which is general framework for packet voice transmission. These packets generated are then launched individually into the packet network. Some packet generated may lag behind other. FIG. 2 in the accompanying illustrative drawings is the effect of variable network delay on playout. Since, continuous voice has to be played out during each talk spurt, a playout delay is applied to the first received packet of each talk spurt. This playout delay adds to the end-to-end mouth to ear (MtoE) delay, and hence there is need to use as small a playout delay as possible, while ensuring continuous speech playout (with a high probability).

The destination host server uses a simple and fast procedure (algorithm), and if any packet, or even an entire row of packets, is delayed or otherwise missing (missing packets), reconstitutes the missing packet. The effect, to the listener, is as if the missing packets had arrived on time. The listener hears a high quality and exact replica of the entire original voice; without any missing segments, i.e. without missing packet.

The originating voice is transmitted by telephone to a server, for example, a computer of an Internet service provider. The server (source node) converts the voice into digital data and forms that data into packets. Each packet is formed with a header having usual origination and destination address. In addition, and novel in that context was, each header has a series of intermediate nodes which defines it's route. In this way the best available route was selected and a number of different routes may be pre-selected for each group of packets.

Since, in transmission of voice, the speech packets launched into the packet network require to be played continuously during each talk spurt, a play out delay is applied to the first received packet of each talk spurt. The play out delay adds to the end-to-end mouth to ear (MtoE) delay, and therefore, an abnormal voice transmission takes place.

In contrast, to support the delivery of real time voice, alternate network design constraints must be considered. For example, such networks often dedicated bandwidth to voice transmission exchanges. However, by dedicating channel bandwidth to voice, efficient communication of data through such networks is seriously impacted. Data communication would have to wait for longer periods of time until dedicated voice bandwidth has been released.

A fast packet network should be transparent to the users. Users of a fast packet network should be able to perform all tasks currently available with a dedicated telephone system. One useful task performed by analog telephone system is voice conferencing, in which more than two individuals participate in a joint telephone discussion. Voice conferencing is a valuable tool for conducting meetings with participants at various locations throughout the world. In telephone networks other than fast packets, the sounds from each conference participant is sent to a central conferencing hub, and at the hub, the sounds are added, and then sent to the conference participants.

Network congestion occurs without prior intimation, and it is time varying, the play out delay is estimated on-line. Conventional technique known for estimating the play out delay uses time-stamps on the transmitted packets, and packet receipt epochs, to obtain a bound on the end-to-end network delay. The obtained bound in turn is used to obtain the play out delay. When T is the calculated bound so that probability (delay>T)<e, where e is a small number, say 0.01 (1%). In case of the first packet in an activity period experiencing delay X₁ (FIG. 2 of the accompanying drawings), the play out delay b for that activity period, can be taken to be max (O,T−X₁), and it facilitates to see that the probability that a packet arrives later than it's scheduled play out time is less than e.

The delays of successive packets are not independent. In fact, the delays are correlated, and this has been found to be true from measured delays in the Internet. In an ideal case that the packet delays in a talk spurt were identical to the delay of the first packet (perfect correlation). In such cases, even though the delays are random, the playout delay required is actually zero. The conventional approach described above, however will still use a positive play out delay. Essentially, the approach ignores the correlations between packet delays, and only works with the marginal distribution of packet delay. Thus, in general, the play delay provided by existing adaptive play out schemes could be larger than necessary. The MtoE delay in interactive speech has to be kept below 200 ms. Allowing for coding delay, packetization delay, and propagation delay there is only about 60 ms available for play out delay. Hence, refined techniques for determining the play out delay may mean the difference between an acceptable and an unacceptable packet voice call.

### BRIEF DESCRIPTION OF THE DRAWINGS

FIG. 1 shows a general framework for packet voice transmission.

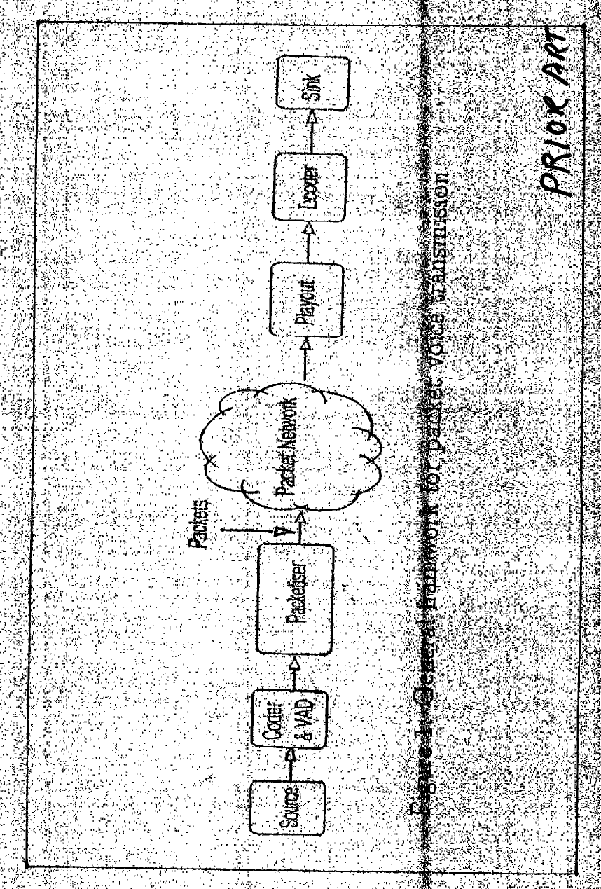

FIG. 2 shows effect of variable network delay on playout.

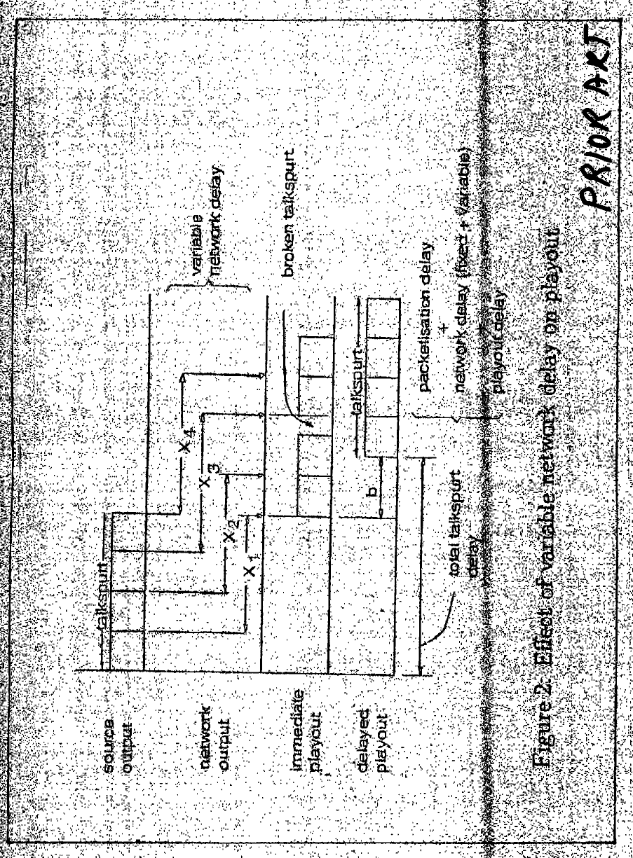

### SUMMARY OF THE INVENTION

An advantage of the present invention is to reduce delay in speech play out in network conferencing in the Internet and the like communication system. The study conducted by the inventors revealed that to reduce delay in speech play out in the network conferencing, play delay as small as possible need to be used.

### DETAILED DESCRIPTION OF THE INVENTION

To overcome the shortcomings of the end-to-end delay bounding method, a technique based on excess play out delay estimation, with a target loss probability has been developed. Unlike conventional obtaining bound on, or a percentile of the end-to-end packet delay, the invention focuses on directly estimating the excess delay required at the beginning of the talks spurt so that straggling packets can catch up. In addition to being based on excess delay, the algorithms for estimating the excess delay required at the beginning of the talks spurt, envisaged according to the present invention have a built-in notion of a target loss probability (TLP). In packetized voice, a packet that arrives later than it's scheduled play out epoch is taken as being “lost”. Such packet need to be interpolated, resulting in reduction in speech quality. Therefore, there is a need to bound the late packet probability; typical target values are 5%-10% if voice packets carry up to 20 ms of speech. Algorithms for estimating the excess delay required at the beginning of the talks spurt, envisaged according to the present invention use the TLP as a parameter and produce an excess play out delay that will achieve this TLP. Thus, by the present invention emerges a class of algorithms called EXD-TLP that provide the excess play out delay for a given target loss probability.

In the general framework the inventors have revived two algorithms. The first algorithm is based on the stochastic approximation (SA) approach, in which it was considered the loss probability function Ploss(h, b), where h is the VAD hangover and b is the play out delay. For fixed hangover, this is a function of b. For the TLP p*, the problem is to solve the equation Ploss(h,b)=p*. The achieved loss probability could be measured with any given value of b. The approach is to iteratively improve an estimate of b using the SA algorithm; the adjustments are driven by the errors between the observed loss probability and the TLP. This algorithm envisaged is named as EXD-TLP-SA.

In reviving of the second algorithm envisaged according to the invention, the used fact for a talks spurt in which packet delays are (X1, X₂, . . . Xₙ), the required play out delay for no packet loss is b=max (Xⱼ−X₁). If a loss probability of p* can be tolerated then 1<=j<=n b* can be used, which is the 1−p* percentile of [(X₂−X₁) . . . (Xₙ−X₁)] (or zero of this percentile is negative). Thus, for each talk spurt the “optimal” play out delay could be estimated. In accordance with one of the embodiments of the invention, exponentially weighted moving average (EWMA) approach was used to obtain a running estimate of the play out delay from the “observed” play delays, which estimate is used in the next talk spurt, which yields another sample, to be used to further correct the estimate. This algorithm is called EXD-TLP-EWMA.

Adaptive control to VAD hangover for optimizing play out delay: Network delay corrections decrease as the time lag between packets increase. Thus, if a talk spurt is long then the delay correction between the first and later packets is going to be small, and a large value of play out delay will be needed. It is clear that a small hangover h will result in shorter talk spurts. Thus, from the point of view of reducing play out delay, a small value of h is good, whereas a larger h helps to make the received speech less sensitive to silence period jitter.

The method envisaged according to the invention is to dynamically adjust h so as to keep the play out delay small. Essentially, in the equation Ploss(h,b)=p*, both the hangerover h and the excess play out delay b can be chosen, so as to minimize b while keeping h above some minimum desirable value. The receiver continuously computes the play out delay so as to meet a target probability of packets arriving later than their scheduled play out time. In optimizing the play out delay, the receiver needs to periodically feed back new h values to the sender.

1. A method for minimizing end-to-end voice delay in packet telephony comprises steps of directly computing an excess play out delay for a given target loss probability; estimating excess delay required at the beginning of a talk spurt, such that straggling packets catch up; providing a built-in notion of target loss probability (TLP) as a parameter and producing excess play out delay; binding late packet probability, thereby emerging a class of algorithms.

2. The method for minimizing end-to-end voice delay in packet telephony of claim 1, one of the said algorithms is based on the stochastic approximation (SA) approach, where loss probability function is Ploss (h, b), where h is the VAD hangover and b is the play out delay.

3. The method for minimizing end-to-end voice delay in packet telephony of claim 2, the b performs the function of fixed hangover.

4. The method for minimizing end-to-end voice delay in packet telephony of claim 2, the TLP p* solves the equation Ploss(h, b).

5. The method for minimizing end-to-end voice delay in packet telephony of claim 2, the achieved loss probability is measured with a given value of b.

6. The method for minimizing end-to-end voice delay in packet telephony of claim 1, another algorithm used fact for a talk spurt in which packet delays are (X1, X₂, . . . Xₙ), the required play out delay for no packet loss is b=max (Xⱼ−X₁).

7. The method for minimizing end-to-end voice delay in packet telephony of claim 6, in case of the tolerated loss probability is p*, 1<=J<=b* is used, which is the 1−p* percentile of [(X₂−X₁) . . . (Xₙ−X₁).

8. The method for minimizing end-to-end voice delay in packet telephony of claim 7, in which the zero of the percentile is negative.

9. The method for minimizing end-to-end voice delay in packet telephony of claims 1 to 6, in which the approach used to obtain a running estimate of the play out delay is by exponentially weighting of moving average (EWMA).

10. The method for minimizing end-to-end voice delay in packet telephony of claim 7, in which the estimate is used in the next talk spurt, yielding another sample to be used to further correct the estimate.

11. The method for minimizing end-to-end voice delay in packet telephony of claims 1 to 7, in which play out delay is kept small by dynamically adjusting the h.

12. The method for minimizing end-to-end voice delay in packet telephony of claims 1 to 8, in the equation Ploss (h,b)=p*, the hangovers h and the excess play out delay b are adopted, so as to minimize b while maintaining h above a minimum desired value.

13. The method for minimizing end-to-end voice delay in packet telephony of claims 1 to 10, in optimizing the play out delay, the receiver is periodically fed with new h values to the sender.

14. The method for minimizing end-to-end voice delay in packet telephony of claims 1 to 11, the achieved loss probability is measured with a given value of the b.

15. The method for minimizing end-to-end voice delay in packet telephony of claims 1 to 12, an estimate of b is iteratively improved by using the stochastic approximation (SA) algorithm.

16. The method for minimizing end-to-end voice delay in packet telephony of any of the preceding claims, the algorithms emerged provide the excess play out iodelay for a given target loss probability.
